(19) United States
(12) Patent Application Publication
(10) Pub. No.: US 2024/0208615 A1
(43) Pub. Date: Jun. 27, 2024

(54) Multifunctional Surfing Equipment Station

(71) Applicant: SHANGHAI YUJET, CO. LTD., Kunshan City (CN)

(72) Inventor: Yu TIAN, Hong Kong (HK)

(21) Appl. No.: 18/418,984

(22) Filed: Jan. 22, 2024

Related U.S. Application Data
(63) Continuation-in-part of application No. 18/314,058, filed on May 8, 2023, now Pat. No. 11,912,376.
(60) Provisional application No. 63/480,716, filed on Jan. 20, 2023.
(60) Provisional application No. 63/480,716, filed on Jan. 20, 2023.

(30) Foreign Application Priority Data
Jul. 8, 2022 (CN) 202210804854.X
Jul. 8, 2022 (CN) 202210805802.4
Jul. 8, 2022 (CN) 202210807458.2
Jul. 8, 2022 (CN) 202210807921.3
Jul. 8, 2022 (CN) 202210808130.2
Jul. 8, 2022 (CN) 202210808181.5
Jul. 8, 2022 (CN) 202210815527.4
Jul. 8, 2022 (CN) 202210815528.9
Oct. 28, 2022 (CN) 202211331990.8
Oct. 28, 2022 (CN) 202211332030.3
Oct. 28, 2022 (CN) 202211332542.X
Oct. 28, 2022 (CN) 202211332654.5
Oct. 28, 2022 (CN) 202211332676.1
Oct. 28, 2022 (CN) 202211341386.3
Oct. 28, 2022 (CN) 202211341387.8
Oct. 28, 2022 (CN) 202211341848.1

(51) Int. Cl. B63B 32/83; H02J 7/00

(52) U.S. Cl. CPC B63B 32/83; H02J 7/0044; B63B 2209/18

(57) ABSTRACT

A multifunctional surfing equipment station wherein the multifunctional surfing equipment station has a storage module for storing multiple surfboards, a power module for charging batteries, and a display module for displaying information. There is also a shower and a changing station within the surfing equipment station.

### CROSS-REFERENCES

This application claims priority to, and is a non-provisional application of, U.S. provisional application Ser. No. 63/480,716, filed Jan. 20, 2023.

This application is a continuation-in-part application of U.S. utility patent application Ser. No. 18/314,058, filed on May 8, 2023, now allowed, which claims priority to, and is a non-provisional patent application of, U.S. provisional patent application No. 63/480,716, filed on Jan. 20, 2023, all of which is hereby incorporated by reference in their entireties.

This application is a continuation-in-part application of U.S. utility patent application Ser. No. 18/314,058, filed on May 8, 2023, now allowed, which claims priority to China Invention Patent Application number 202211332654.5, filed on Oct. 28, 2022, now pending, which is hereby expressly incorporated by reference as part of the present disclosure.

This application is a continuation-in-part application of U.S. utility patent application Ser. No. 18/314,058, filed on May 8, 2023, now allowed, which claims priority to China Invention Patent Application number 202211332676.1, filed on Oct. 28, 2022, now pending, which is hereby expressly incorporated by reference as part of the present disclosure.

This application is a continuation-in-part application of U.S. utility patent application Ser. No. 18/314,058, filed on May 8, 2023, now allowed, which claims priority to China Invention Patent Application number 202211341386.3, filed on Oct. 28, 2022, now pending, which is hereby expressly incorporated by reference as part of the present disclosure.

This application is a continuation-in-part application of U.S. utility patent application Ser. No. 18/314,058, filed on May 8, 2023, now allowed, which claims priority to China Invention Patent Application number 202211341387.8, filed on Oct. 28, 2022, now pending, which is hereby expressly incorporated by reference as part of the present disclosure.

This application is a continuation-in-part application of U.S. utility patent application Ser. No. 18/314,058, filed on May 8, 2023, now allowed, which claims priority to China Invention Patent Application number 202211341848.1, filed on Oct. 28, 2022, now pending, which is hereby expressly incorporated by reference as part of the present disclosure.

This application is a continuation-in-part application of U.S. utility patent application Ser. No. 18/314,058, filed on May 8, 2023, now allowed, which claims priority to China Invention Patent Application number 202211332030.3, filed on Oct. 28, 2022, now pending, which is hereby expressly incorporated by reference as part of the present disclosure.

This application is a continuation-in-part application of U.S. utility patent application Ser. No. 18/314,058, filed on May 8, 2023, now allowed, which claims priority to China Invention Patent Application number 202211332542.X, filed on Oct. 28, 2022, now pending, which is hereby expressly incorporated by reference as part of the present disclosure.

This application is a continuation-in-part application of U.S. utility patent application Ser. No. 18/314,058, filed on May 8, 2023, now allowed, which claims priority to China Invention Patent Application number 202211331990.8, filed on Oct. 28, 2022, now pending, which is hereby expressly incorporated by reference as part of the present disclosure.

This application is a continuation-in-part application of U.S. utility patent application Ser. No. 18/314,058, filed on May 8, 2023, filed on May 8, 2023, now allowed, which claims priority to China Invention Patent Application number 202210807458.2, filed on Jul. 8, 2022, now pending, which is hereby expressly incorporated by reference as part of the present disclosure.

This application is a continuation-in-part application of U.S. utility patent application Ser. No. 18/314,058, filed on May 8, 2023, filed on May 8, 2023, now allowed, which claims priority to China Invention Patent Application number 202210805802.4, filed on Jul. 08, 2022, now pending, which is hereby expressly incorporated by reference as part of the present disclosure.

This application is a continuation-in-part application of U.S. utility patent application Ser. No. 18/314,058, filed on May 8, 2023, now allowed, which claims priority to China Invention Patent Application number 202210804854.X, filed on Jul. 8, 2022, now pending, which is hereby expressly incorporated by reference as part of the present disclosure.

This application is a continuation-in-part application of U.S. utility patent application Ser. No. 18/314,058, filed on May 8, 2023, now allowed, which claims priority to China Invention Patent Application number 202210807921.3, filed on Jul. 8, 2022, now pending, which is hereby expressly incorporated by reference as part of the present disclosure.

This application is a continuation-in-part application of U.S. utility patent application Ser. No. 18/314,058, filed on May 8, 2023, now allowed, which claims priority to China Invention Patent Application number 202210815528.9, filed on Jul. 8, 2022, now pending, which is hereby expressly incorporated by reference as part of the present disclosure.

This application is a continuation-in-part application of U.S. utility patent application Ser. No. 18/314,058, filed on May 8, 2023, now allowed, which claims priority to China Invention Patent Application number 202210808130.2, filed on Jul. 8, 2022, now pending, which is hereby expressly incorporated by reference as part of the present disclosure.

This application is a continuation-in-part application of U.S. utility patent application Ser. No. 18/314,058, filed on May 8, 2023, now allowed, which claims priority to China Invention Patent Application number 202210808181.5, filed on Jul. 8, 2022, now pending, which is hereby expressly incorporated by reference as part of the present disclosure.

This application is a continuation-in-part application of U.S. utility patent application Ser. No. 18/314,058, filed on May 8, 2023, now allowed, which claims priority to China Invention Patent Application number 202210815527.4, filed on Jul. 8, 2022, now pending, which is hereby expressly incorporated by reference as part of the present disclosure.

### FIELD OF THE DISCLOSURE

The invention relates to the technical field of surfing equipment, in particular to a multifunctional surfing equipment station.

### BACKGROUND OF THE INVENTION

Surfing is becoming more and more popular in some coastal cities. In addition to traditional surfboards, electric surfboards are now becoming more and more popular among users. However, the battery life of electric surfboards has certain limitations. There remains a need for a way to way to manage charging and storing multiple electric surfboards. There remains a need to provide a facility for managing a leasing business of electric surfboards.

### SUMMARY OF THE INVENTION

The purpose of the invention is to provide a multifunctional surfing equipment station. The multifunctional surfing equipment station of the present application is convenient for transportation, and is convenient for users to store surfboards and replace surfboard batteries.

For this purpose, the first aspect of the invention provides a multifunctional surfing equipment station, which comprises: a storage module located on the side of the station and used to store surfing equipment; a power module located on the side of the station and used to store power supply device, the power supply device is used to supply power to the surfing equipment.

Moreover, the multifunctional surfing equipment station can further comprise a station body and four side panels surrounding the station body, the storage module and the power module are located on the side of the station body, and each side panel is configured to pivot open and close about the edge of the station body to enclose or display the content of the station.

Moreover, the storage module and the power module are open towards the corresponding side panels, and each side panel can pivot around the upper edge of the station body to enclose or display the storage module and the power module.

Moreover, the power supply device comprising a charging box and a backup battery, the backup battery can be installed on the surfing equipment and used to supply the surfing equipment, the charging box is used to charge the backup battery.

Moreover, on top of each side panel is also installed with a solar panel, the solar panel is electrically connected to the power module.

Moreover, the power module comprises a charging plug, the charging plug can be connected to the municipal power grid through the charging plug.

Moreover, the side of the station body is also equipped with a display module, the display module can be used to introduce the function of the multifunctional surfing equipment station.

Moreover, the interior of the station also comprises a shower space and a changing room, which can be used by users for showering and changing clothes.

Moreover, the station body is made of plastic steel profiles, which can prevent corrosion by seaside moisture.

Moreover, the bottom of the station body also comprises a rolling device, the rolling device can be used for short distance movement of the station body

The multifunctional surfing equipment station of the present application is convenient for transportation between various surfing places, and is convenient for users to store surfboards and replace surfboard batteries.

### BRIEF DESCRIPTION OF DRAWINGS

FIG. 1 shows the sectional view of the multifunctional surfing equipment station provided by the embodiment of the present invention;

FIG. 2 shows the side view of the display module of the multifunctional surfing equipment station provided by the embodiment of the present invention;

FIG. 3 shows the side view of the power module of the multifunctional surfing equipment station provided by the embodiment of the present invention;

FIG. 4 shows the interior view of the multifunctional surfing equipment station provided by the embodiment of the present invention.

### DETAILED DESCRIPTION

The different aspects of the various embodiments can now be better understood by turning to the following detailed description of the embodiments, which are presented as illustrated examples of the embodiments as defined in the claims. It is expressly understood that the embodiments as defined by the claims may be broader than the illustrated embodiments described below.

It will, nevertheless, be understood that no limitation of the scope of the disclosure is thereby intended; any alterations and further modifications of the described or illustrated embodiments and any further applications of the principles of the disclosure as illustrated therein are contemplated as would normally occur to one skilled in the art to which the disclosure relates.

The technical solutions of the present invention will be further described below in conjunction with the accompanying drawings and embodiments. It should be understood that the specific embodiments described here are only used to explain the present invention, but not to limit the present invention. In addition, it should be noted that, for the convenience of description, only the parts related to the present invention are shown in the drawings but not all of them.

In the description of the present invention, it should be noted that unless otherwise specified and limited, the terms “installation”, “connection” and “connected” should be understood in a broad sense, for example, it can be a fixed connection or a detachable connection; it can be a mechanical connection or an electrical connection; it can be a direct connection or an indirect connection through an intermediary, and it can be the internal communication of two components. Those of ordinary skill in the art can understand the specific meanings of the above terms in the present invention in specific situations.

In the present invention, unless otherwise clearly specified and limited, a first feature being “on” or “above” a second feature may include direct contact between the first and second features, and may also include the first and second features not in direct contact but through another characteristic contact between them. Moreover, “above”, and “on” the first feature on the second feature include that the first feature is directly above and obliquely above the second feature, or simply means that the first feature is horizontally higher than the second feature. A first feature being “Below”, “beneath” or “under” the second feature include that the first feature is directly below and obliquely below the second feature, or simply means that the first feature has a lower level than the second feature.

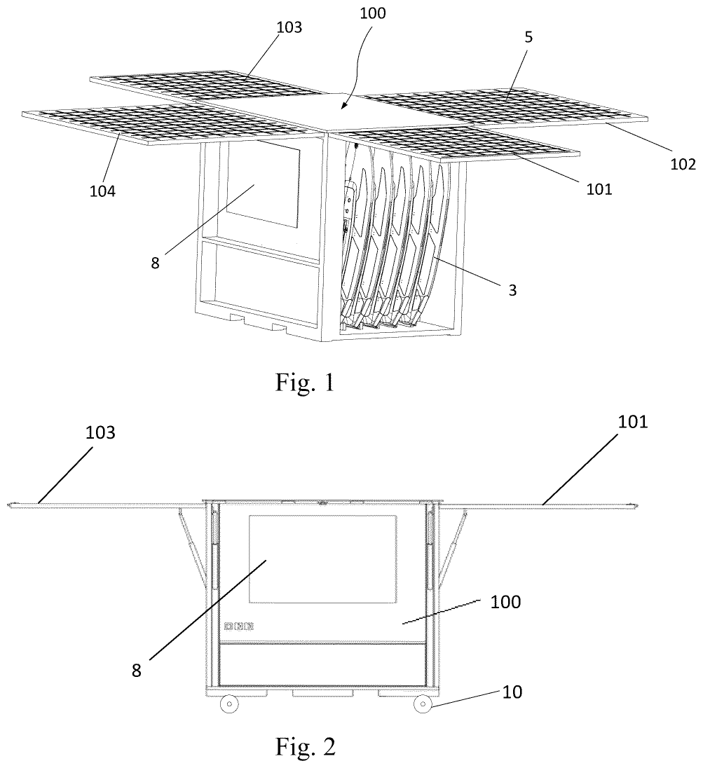

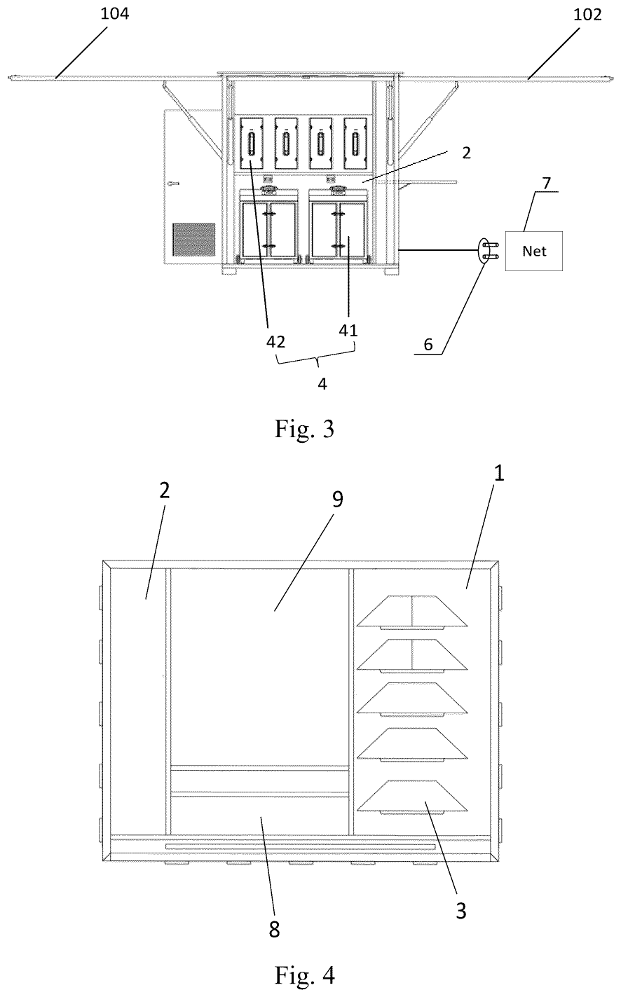

The following describes embodiments of the present application with reference to the accompanying drawings. As shown in FIGS. 1 to 4, the multifunctional surfing equipment station of the present application includes a storage module 1 and a power module 2, the storage module 1 is located on the side of the station and used to store surfing equipment, the power module 2 is located on the side of the station and used to store power supply device, the power supply device is used to supply power to the surfing equipment.

Specifically, a station body 100 and four side panels (101, 102, 103 and 104) surrounding the station body 100, the storage module 1 and the power module 2 are respectively located on the side of the station body 100. Each side panel (101, 102, 103 and 104) can pivot around the edge of the station body 100 to enclose or display the station body 100.

Specifically, the storage module 1 and the power module 2 are open towards the corresponding side panel. Each side panel is connected with the station body 100 through a hydraulic rod. Each side panel can pivot around the edge of the station body through the hydraulic rod. The side panel can pivot around upper edge of the station body 100 to enclose or display the storage module 1 and power module 2. Specifically, the side panel pivots downward around the upper edge of the station body 100 to close the storage module 1 or the power module 2, and the side panel pivots upward around the upper edge of the station body 100 to display the storage module 1 or the power module 2.

The power supply device 4 includes a charging box 41 and a rechargeable battery 42. The rechargeable battery 42 is installed in the surfing equipment 3 and used to supply power for the surfing equipment 3. The charging box 41 is used to charge the rechargeable battery 42. The power module 2 includes a charging plug 6, through the charging plug 6 the power module 2 can be connected to the municipal power grid 7. The station body 100 can be made of PVC profiles, which can prevent corrosion by seaside moisture. The bottom of the station body 100 can also include a rolling device 10. The rolling device 10 can be used to move the station body 100 over a short distance, it can be convenient to move the station body 100. The station body 100 also includes a changing room 9 for users to change clothes. There can also be a shower room inside the station body 100 for users to take a shower. Furthermore, a solar panel 5 can be installed on top of each side panel (101, 102, 103 and 104) . The solar panel 5 is electrically connected to the power module 2 and can provide power for the power module 2. Similarly, solar panels 5 can also be installed on each side panel to increase power supply capacity. Furthermore, a display module 8 is also provided on the side of the station body 100. The display module 8 can be used to introduce the functions of the multi-functional surfing equipment station. The display module 8 can be a television monitor. In one contemplated embodiment, the display module 8 provides sales and/or leasing information about the surfboards.

The multifunctional surfing equipment station of the present application is convenient for transportation between various surfing places, and is convenient for users to store surfboards and replace surfboard batteries.

The above embodiments only illustrate the principles and effects of the present application. Anyone familiar with this technology can modify or change the above embodiments without violating the purpose of this application. Therefore, all equivalent modifications or changes made by those with ordinary skill in the art without departing from the purpose disclosed in this application shall still be covered by the claims of this application..

1. A multifunctional surfing equipment station, the multifunctional surfing equipment station comprising
a storage module located on the side of the station and used to store a plurality of surfboards;
a power module located on the side of the station and used to store a power supply device, the power supply device is used to supply power to the surfing equipment.

2. The multifunctional surfing equipment station according to claim 1, further comprising a station body and four side panels surrounding the station body, the storage module is enclosed with a first of the four side panels; and the power module is enclosed within a second of the four side panels; wherein each of the four side panels is pivotable.

3. The multifunctional surfing equipment station according to claim 1, wherein the power supply device includes a charging box and a backup battery, the backup battery can be installed on the surfboard to supply power to the surfboard, the charging box is portable and can be removed from the surfing equipment station to charge the backup battery.

4. The multifunctional surfing equipment station according to claim 2, further comprising a solar panel disposed on the four side panels, wherein the solar panel is electrically connected to the power module.

5. The multifunctional surfing equipment station according to claim 4, wherein the power module includes a charging plug, the charging plug can be connected to the municipal power grid through the charging plug.

6. The multifunctional surfing equipment station according to claim 2, further comprising a display module disposed to display information.

7. The multifunctional surfing equipment station according to claim 2, further comprising a shower space and a changing room in an interior of the surfing equipment station.

8. The multifunctional surfing equipment station according to claim 2, wherein the station body is made of plastic steel profiles to minimize corrosion.

9. The multifunctional surfing equipment station according to claim 1, a bottom of the station body includes a plurality of wheels.
